(19) United States
(12) Patent Application Publication
(10) Pub. No.: US 2025/0050905 A1
(43) Pub. Date: Feb. 13, 2025

(54) AUTONOMOUS DRIVING DEVICE

(71) Applicant: TOYOTA JIDOSHA KABUSHIKI KAISHA, Toyota-shi (JP)

(72) Inventor: Kentaro KAMIJO, Susono-shi (JP)

(73) Assignee: TOYOTA JIDOSHA KABUSHIKI KAISHA, Toyota-shi (JP)

(21) Appl. No.: 18/659,027

(22) Filed: May 9, 2024

(30) Foreign Application Priority Data
Aug. 8, 2023 (JP) 2023-129179

(51) Int. Cl. B60W 60/00; B60W 50/14

(52) U.S. Cl. CPC B60W 60/001; B60W 50/14; B60W 2050/143; B60W 2050/146; B60W 2540/215

(57) ABSTRACT

The autonomous driving device automatically generates a route from the departure point to the destination as a target route, and executes autonomous travel control for automatically driving the host vehicle to the destination along the target route. The automatic traveling control is configured such that, when an operator of the host vehicle sets a specific point and a specific traveling, which are points at which the host vehicle traveling along the target route wants to perform a specific traveling as a specific traveling, the host vehicle performs the specific traveling at the specific point when the host vehicle is traveling by the automatic traveling control.

### CROSS-REFERENCE TO RELATED APPLICATION

This application claims priority to Japanese Patent Application No. 2023-129179 filed on Aug. 8, 2023, incorporated herein by reference in its entirety.

### BACKGROUND

### 1. Technical Field

The present disclosure relates to an autonomous driving device.

### 2. Description of Related Art

An autonomous driving device that performs autonomous driving of a host vehicle is known. As the autonomous driving device, there is also known an autonomous driving device that stores a traveling route etc. of a host vehicle when the host vehicle is caused to travel by manual driving and, when a scheduled traveling route etc. of the host vehicle to be traveled by autonomous driving deviates from the stored traveling route etc. of the host vehicle to a certain degree, causes the host vehicle to travel by autonomous driving according to the scheduled traveling route etc. (see, for example, Japanese Patent No. 6542196 (JP 6542196 B)).

### SUMMARY

In the related-art autonomous driving device, when an operator of the host vehicle (in particular, a driver) wants the host vehicle to perform a specific travel at a specific point during the autonomous driving of the host vehicle but the scheduled traveling route etc. reflecting the specific travel at the specific point deviates, to a degree higher than the certain degree, from the traveling route etc. of the host vehicle during the manual driving of the host vehicle, the host vehicle cannot travel by the autonomous driving reflecting the specific travel at the specific point.

An object of the present disclosure is to provide an autonomous driving device in which an operator of a host vehicle can cause the host vehicle to travel by autonomous driving while causing the host vehicle to perform a desired travel at a desired point.

An autonomous driving device according to the present disclosure includes a control device configured to execute autonomous driving control for automatically generating a route from a departure point to a destination as a target route and autonomously driving a host vehicle to the destination along the target route. The autonomous driving control is control for, when an operator of the host vehicle sets a specific travel and a specific point where the operator desires the host vehicle traveling along the target route to perform the specific travel, causing the host vehicle to perform the specific travel at the specific point while the host vehicle is traveling under the autonomous driving control.

With the autonomous driving device of the present disclosure, the host vehicle can travel under the autonomous driving control while performing the specific travel at the specific point. That is, the operator of the host vehicle can cause the host vehicle to travel by autonomous driving while causing the host vehicle to perform the desired travel at the desired point.

In the autonomous driving device of the present disclosure, the specific point may be, for example, a deceleration point where the operator desires to decelerate the host vehicle, a lane change point where the operator desires to change a lane of the host vehicle, or a stopover point where the operator desires to temporarily stop the host vehicle off the target route. When the specific point is the deceleration point, the specific travel may be deceleration of the host vehicle. When the specific point is the lane change point, the specific travel may be lane change of the host vehicle. When the specific point is the stopover point, the specific travel may be entry and stop of the host vehicle at the stopover point.

With the autonomous driving device of the present disclosure, while the host vehicle is traveling under the autonomous driving control, the host vehicle can autonomously decelerate at the deceleration point where the operator desires to decelerate the host vehicle, change the lane at the lane change point where the operator desires to change the lane of the host vehicle, or enter and stop at the stopover point where the operator desires to temporarily stop the host vehicle off the target route.

In the autonomous driving device of the present disclosure, the control device may be configured to, when the specific point is set by the operator and a performability condition that the host vehicle is able to perform, at the set specific point, the specific travel set in association with the specific point is not satisfied, cause the host vehicle not to perform, at the set specific point, the specific travel set in association with the specific point while the host vehicle is traveling under the autonomous driving control.

With the autonomous driving device of the present disclosure, the host vehicle is caused not to perform the specific travel at the specific point when the host vehicle is unable to perform the specific travel at the specific point. Thus, the host vehicle can be autonomously driven more appropriately.

In the autonomous driving device of the present disclosure, the control device may be configured to, when the performability condition is not satisfied, notify the operator that the host vehicle is unable to perform, at the set specific point, the specific travel set in association with the specific point.

With the autonomous driving device of the present disclosure, the operator can recognize that the host vehicle is unable to perform the specific travel at the specific point set by the operator.

The components of the present disclosure are not limited to those in the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an autonomous driving device according to an embodiment of the present disclosure;

FIG. 2 is a diagram showing a target route; and

FIG. 3 is a flowchart illustrating a routine executed by the autonomous driving device according to the embodiment of the present disclosure.

### DETAILED DESCRIPTION OF EMBODIMENTS

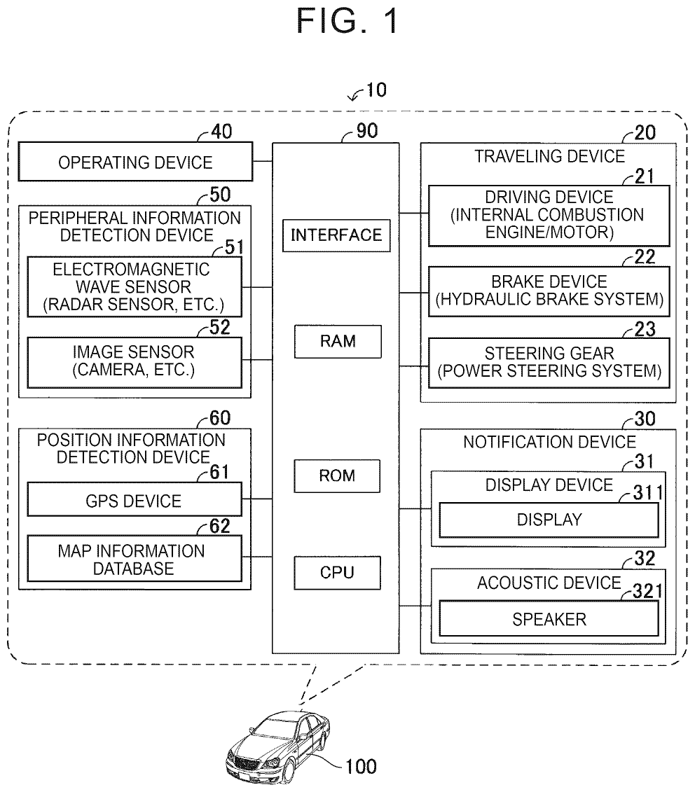

Hereinafter, an autonomous driving device according to an embodiment of the present disclosure will be described with reference to the drawings. FIG. 1 shows an autonomous driving device 10. The autonomous driving device 10 is mounted on the host vehicle 100. Hereinafter, the autonomous driving device 10 will be described by taking as an example a case where the operator of the host vehicle 100 rides on the host vehicle 100 and drives the host vehicle 100 (that is, the driver of the host vehicle 100).

However, the operator of the host vehicle 100 may be a person who drives the host vehicle 100 remotely without getting on the host vehicle 100 (that is, a remote operator of the host vehicle 100). When the operator of the host vehicle 100 is a remote operator, the autonomous driving device 10 is mounted on the host vehicle 100 and a remote control facility installed outside the host vehicle 100 for remotely driving the host vehicle 100. Further, the functions of the autonomous driving device 10 described below are shared by the autonomous driving device 10 mounted on the host vehicle 100 and the autonomous driving device 10 mounted on the remote control facility.

As illustrated in FIG. 1, the autonomous driving device 10 includes an ECU (electronic control device) 90 as a control device. ECU 90 includes a microcomputer as a main part. The microcomputer includes a storage medium such as a CPU, ROM, RAM and a non-volatile memory, an interface, and the like. CPU implements various functions by executing instructions, programs, or routines stored in a storage medium. In particular, in the present example, the autonomous driving device 10 stores, in a storage medium, a program for realizing various controls executed by the autonomous driving device 10.

In the present embodiment, the autonomous driving device 10 includes only one ECU 90. However, the autonomous driving device 10 may include a plurality of ECU, and may be configured to share the functions of the autonomous driving device 10 described below by the respective ECU.

Further, the autonomous driving device 10 may be configured to be able to update a program stored in a storage medium by wireless communication (for example, Internet communication) with an external apparatus.

### Traveling Device

Further, the host vehicle 100 is equipped with a traveling device 20. The traveling device 20 includes a driving device 21, a braking device 22, and a steering device 23.

The driving device 21 is a device that outputs a driving torque (driving force) applied to the host vehicle 100 in order to cause the host vehicle 100 to travel. The driving device 21 is, for example, an internal combustion engine, a motor, or the like. The driving device 21 is electrically connected to ECU 90. The autonomous driving device 10 can control the driving torque output from the driving device 21 by controlling the operation of the driving device 21.

The braking device 22 is a device that outputs a braking torque (braking force) applied to the host vehicle 100 for braking the host vehicle 100, and is, for example, a hydraulic brake device. The braking device 22 is electrically connected to ECU 90. The autonomous driving device 10 can control the braking torque output from the braking device 22 by controlling the operation of the braking device 22.

The steering device 23 is a device that outputs a steering torque (steering force) applied to the host vehicle 100 in order to steer the host vehicle 100, and is, for example, a power steering device. The steering device 23 is electrically connected to ECU 90. The autonomous driving device 10 can control the steering torque output from the steering device 23 by controlling the operation of the steering device 23.

When the autonomous driving control described later is executed, the autonomous driving device 10 automatically or autonomously controls the operation of the traveling device 20 to cause the host vehicle 100 to automatically or autonomously travel.

### Sensors, Etc.

Further, the host vehicle 100 is equipped with a notification device 30, an operation device 40, a peripheral information detection device 50, and a position information detection device 60.

The notification device 30 is a device that performs various notifications to the driver. The notification device 30 includes a display device 31 and an acoustic device 32.

The display device 31 is a device that displays various images. The display device 31 includes a display 311. The display device 31 is electrically connected to ECU 90. The autonomous driving device 10 can display various images on the display 311 by the display device 31.

The acoustic device 32 is a device that outputs various sounds. The acoustic device 32 includes a speaker 321. The acoustic device 32 is electrically connected to ECU 90. The autonomous driving device 10 can output various sounds from the speaker 321 by the acoustic device 32.

The operation device 40 is a device that performs various operations for causing a driver to travel the host vehicle 100 by using automatic driving, which will be described later. In this example, the operation device 40 is configured as a so-called touch panel that allows the display 311 of the display device 31 to sense that the driver touches the screen with a finger. The operation device 40 is realized by displaying various images on the display 311 by the display device 31.

The peripheral information detection device 50 is a device that detects information about the surroundings of the host vehicle 100. In this example, the peripheral information detection device 50 includes an electromagnetic wave sensor 51 and an image sensor 52.

The electromagnetic wave sensor 51 is, for example, a radar sensor (such as a millimeter-wave radar), a sound wave sensor such as an ultrasonic sensor (clearance sonar), or an optical sensor such as a laser radar (LiDAR). The electromagnetic wave sensor 51 is electrically connected to ECU 90. The autonomous driving device 10 acquires, as the surroundings detected information IS, information related to an object existing around the host vehicle 100 by the electromagnetic wave sensor 51.

The image sensor 52 is, for example, a camera, and is electrically connected to ECU 90. The autonomous driving device 10 acquires image information about the surroundings of the host vehicle 100 as the surroundings detected information IS by the image sensor 52.

The autonomous driving device 10 automatically or autonomously controls the operation of the traveling device 20 so that the host vehicle 100 travels along the target route Rtgt by using the surroundings detected information IS when the host vehicle 100 is caused to travel by the autonomous driving control described later.

The position information detection device 60 includes a GPS device 61 and a map information database 62.

GPS device 61 is a device that receives a so-called GPS signal. GPS device 61 is electrically connected to ECU 90. The autonomous driving device 10 can acquire a GPS signal via GPS device 61 and identify (acquire) the position of the host vehicle 100 based on the acquired GPS signal.

The map information database 62 is a database storing map information and is electrically connected to ECU 90. The autonomous driving device 10 can know which location on the map indicated by the map information is located by the host vehicle 100 based on the position of the host vehicle 100 and the map information specified from GPS signal.

### Operation of Autonomous Driving Device

Next, the operation of the autonomous driving device 10 will be described.

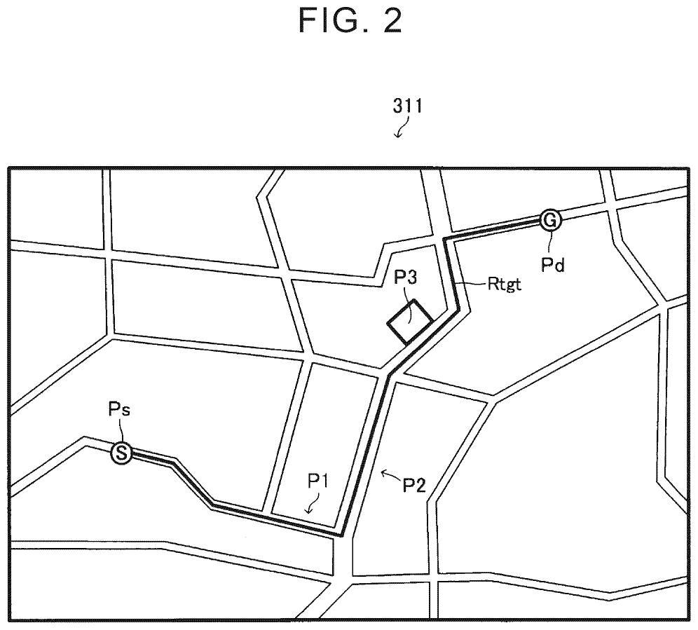

As illustrated in FIG. 2, the autonomous driving device 10 is configured to automatically generate a route from the departure point Ps to the destination Pd as the target route Rtgt. Further, the autonomous driving device 10 is configured to execute autonomous travel control that causes the host vehicle 100 to automatically travel along the target route Rtgt to the destination Pd.

In the present embodiment, the automatic traveling control is configured such that, when the driver of the host vehicle 100 sets a point (specific point Pp) at which the host vehicle 100 traveling along the target route Rtgt wants to perform a specific traveling and a specific traveling, the host vehicle 100 performs the specific traveling at the specific point Pp while the host vehicle 100 is traveling by the automatic traveling control.

The point set as the specific point Pp is, for example, a point (deceleration point P1) at which the driver desires to decelerate the host vehicle 100, a point (lane change point P2) at which the driver desires to change the lane of the host vehicle 100, and a point (stopover point P3) at which the driver desires to temporarily stop the host vehicle 100 by deviating from the target route Rtgt. The deceleration point P1 is, for example, a point in front of a location where the host vehicle 100 turns right and left, or a point in front of a point having a pause line. The stopover point P3 is, for example, a store such as a convenience store or a parking lot.

Therefore, when the specific point Pp is the deceleration point P1, the specific travel is the deceleration of the host vehicle 100. When the specific point Pp is the lane change point P2, the specific travel is the lane change of the host vehicle 100. When the specific point Pp is the stopover point P3, the specific travel is the entry of the host vehicle 100 to the stopover point P3 and the stop at the stopover point P3.

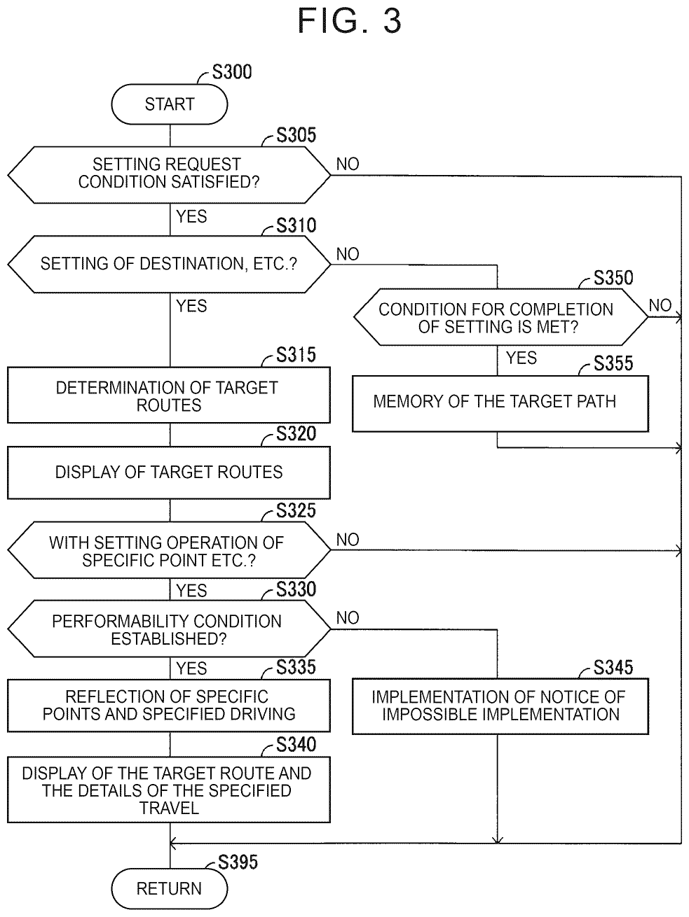

The autonomous driving device 10 determines the target route Rtgt used for the autonomous driving control by reflecting the specific point Pp and the specific travel by executing the routine illustrated in FIG. 3 at predetermined calculation intervals. Therefore, at a predetermined timing, the autonomous driving device 10 starts the processing from S300, advances the processing to S305, and determines whether or not the setting request condition C1 is satisfied.

The setting request condition C1 is a condition that setting (autonomous driving setting) of a destination Pd or the like used for autonomous driving control is requested. The driver can request the autonomous driving setting from the autonomous driving device 10 by touching the setting request image displayed on the display 311 with a finger. When the autonomous driving setting is requested, the autonomous driving device 10 displays a map image on the display 311 as illustrated in FIG. 2. The map image displayed at this time is a map image representing a map around the host vehicle 100. The autonomous driving device 10 acquires map information about the surroundings of the host vehicle 100 from the map information database 62 based on the present position of the host vehicle 100 specified by GPS device 61. The autonomous driving device 10 displays a map image around the host vehicle 100 on the display 311 based on the map information.

In the following description, the term “map image” means a map image displayed on the display 311 unless otherwise specified.

When S305 determines “Yes”, the autonomous driving device 10 advances the process to S310 and determines whether or not an operation for setting the departure point Ps and the destination Pd (an operation for setting the destination Pd or the like) has been performed by the driver. The departure point Ps is a point at which the host vehicle 100 starts traveling under the autonomous driving control. The destination Pd is a point at which the host vehicle 100 is allowed to reach by autonomous driving control. The driver can designate the departure point Ps and the destination Pd by touching, with his/her finger, a point of the map image corresponding to a point desired to be set to the departure point Ps and a point desired to be set to the destination Pd on the map image. Then, the driver can set the designated departure point Ps and the destination Pd as the departure point Ps and the destination Pd to be used for determining the target route Rtgt by touching the approved images displayed on the display 311 with his/her finger.

When the autonomous driving device 10 determines “Yes” in S310, the process proceeds to S315, and a route for causing the host vehicle 100 to travel from the departure point Ps to the destination Pd by autonomous driving is determined as the target route Rtgt.

Next, the autonomous driving device 10 advances the process to S320 and displays the determined target route Rtgt on the map images as illustrated in FIG. 2.

Next, the autonomous driving device 10 advances the process to S325, and determines whether or not an operation of setting the specific point Pp and the specific travel (a setting operation of the specific point Pp or the like) has been performed.

As described above, the point set as the specific point Pp is, for example, the deceleration point P1, the lane change point P2, and the stopover point P3. The driver can designate the specific point Pp by touching the location of the map images corresponding to the location desired to be set as the specific point Pp with his/her finger. Further, the driver touches a plurality of specific travel selection images displayed on the display 311 with his/her finger to designate a specific travel desired to be performed by the host vehicle 100 at the specific point Pp. Then, the driver touches the approved images displayed on the display 311 with his/her finger to set the specific point Pp and the specified travel as the specific point Pp and the specified travel to be reflected in the target route Rtgt, respectively.

When S325 determines “Yes”, the autonomous driving device 10 advances the process to S330 and determines whether or not the performability condition C2 is satisfied.

The performability condition C2 is established when the host vehicle 100 is allowed to perform the specific travel set corresponding to the specific point Pp at the specific point Pp set by the driver. The case where the host vehicle 100 cannot perform the specific travel set corresponding to the specific point Pp in the specific point Pp is, for example, the following case.
(1) When the deceleration of the host vehicle 100 in the specific point Pp is prohibited under the road traffic law in the case where the specific point Pp is the deceleration point P1.
(2) When the specific point Pp is the lane change point P2, and when the lane change of the host vehicle 100 in the specific point Pp is prohibited under the road traffic law.
(3) When there is only one lane on which the host vehicle 100 can travel in the specific point Pp when the specific point Pp is the lane change point P2.
(4) When the host vehicle 100 is unable to enter the specific point Pp due to the construction of the roadway when the specific point Pp is the stopover point P3. For example, when the stopover point P3 is located beyond the oncoming lane, but a structural object such as a center separating zone exists between the oncoming lane and the lane on which the host vehicle 100 is traveling, and the host vehicle 100 cannot enter the specific point Pp.
(5) For the control accuracy of the autonomous driving control, when it is determined that it is difficult or impossible to cause the host vehicle 100 to perform the specific traveling at the specific point Pp.

When S330 determines “Yes”, the autonomous driving device 10 advances the process to S335 and determines the target route Rtgt reflecting the specific point Pp and the specific travel.

Next, the autonomous driving device 10 advances the process to S340, and displays, on the map image, the specific point Pp and the target route Rtgt determined by reflecting the specific travel, and also displays the content of the specific travel set corresponding to the specific point Pp in the location of the map image corresponding to the specific point Pp.

Then, the autonomous driving device 10 advances the processing to S395, and ends the processing of this routine once.

On the other hand, when S330 determines “No”, the autonomous driving device 10 advances the process to S345 and executes the execution disable notification. Here, the specific point Pp and the specific travel are not reflected in the target route Rtgt.

The non-execution notification is a process of notifying the driver that the host vehicle 100 cannot perform the specific travel set corresponding to the specific point Pp in the specific point Pp. In the present embodiment, the non-execution notification is performed by either or both of displaying on the display 311 an image indicating that the host vehicle 100 cannot perform the specific travel set corresponding to the specific point Pp at the specific point Pp, and outputting, from the speaker 321, an audio indicating that the host vehicle 100 cannot perform the specific travel set corresponding to the specific point Pp at the specific point Pp.

Then, the autonomous driving device 10 advances the processing to S395, and ends the processing of this routine once.

When S310 determines “No”, the autonomous driving device 10 advances the process to S350 and determines whether or not the setting termination-condition C3 is satisfied.

The setting termination condition C3 is established when it is determined that the setting of the specific point Pp and the specific travel by the driver has been completed. The autonomous driving device 10 displays on the display 311 an image (setting completion image) touched by the driver with a finger to finish the setting of the specific point Pp and the specific travel. When the driver touches the setting end images with a finger, the autonomous driving device 10 determines that the setting of the specific point Pp and the specific travel by the driver has been completed.

When S350 determines “Yes”, the autonomous driving device 10 advances the process to S355 and stores the target route Rtgt determined at that time as the final target route Rtgt used for the autonomous driving control. Then, the autonomous driving device 10 advances the processing to S395, and ends the processing of this routine once.

Accordingly, when the host vehicle 100 is caused to travel by the automatic driving control, the autonomous driving device 10 causes the host vehicle 100 to travel along the stored target route Rtgt. When the host vehicle 100 reaches the specific point Pp while the host vehicle 100 is being driven by the autonomous driving control, the autonomous driving device 10 causes the host vehicle 100 to travel so that the host vehicle 100 performs the specific travel set corresponding to the specific point Pp.

When the autonomous driving device 10 determines “No” in S305, S325 or S350, the process proceeds directly to S395, and the process of this routine is terminated once.

The above is the operation of the autonomous driving device 10. According to the autonomous driving device 10, it is possible to cause the host vehicle 100 to travel by autonomous driving control while causing the host vehicle 100 to perform the specified travel at the specific point Pp. That is, it is possible to drive the host vehicle 100 by automatic operation while causing the driver of the host vehicle 100 to perform the traveling desired at the desired point to the host vehicle 100.

The present disclosure is not limited to the above embodiment, and various modifications can be adopted within the scope of the present disclosure.

For example, the autonomous driving device 10 may be configured to display a road on which the host vehicle 100 can travel by autonomous driving control in view of control accuracy when the setting request condition C1 is satisfied, and determine a target route Rtgt by selecting a road desired by the driver from among the roads.

Further, the autonomous driving device 10 may be configured to execute autonomous driving control using target route Rtgt determined by an application downloaded to a mobile telephone such as a smart phone. In this situation, the driver can determine the target route Rtgt by using the application of the mobile telephone, and drive the host vehicle 100 by autonomous driving control using the target route Rtgt.

In addition, the autonomous driving device 10 may be configured to allow the driver to select whether or not to perform the specific travel set corresponding to the specific point Pp when the host vehicle 100 approaches the specific point Pp while the host vehicle 100 is being driven by the autonomous driving control. In this case, the autonomous driving device 10 displays an approval image on the display 311, and when the driver touches the approval image with a finger, it determines that the driver has approved (selected) the specific traveling, and causes the host vehicle 100 to perform the specific traveling.

Alternatively, the autonomous driving device 10 may be configured such that, when the host vehicle 100 approaches the specific point Pp while the host vehicle 100 is being driven by the autonomous driving control, the driver is notified by the notification device 30 that the specific traveling set corresponding to the specific point Pp is performed, and then the host vehicle 100 is caused to perform the specific traveling.

What is claimed is:

1. An autonomous driving device comprising a control device configured to execute autonomous driving control for automatically generating a route from a departure point to a destination as a target route and autonomously driving a host vehicle to the destination along the target route, wherein
the autonomous driving control is control for, when an operator of the host vehicle sets a specific travel and a specific point where the operator desires the host vehicle traveling along the target route to perform the specific travel, causing the host vehicle to perform the specific travel at the specific point while the host vehicle is traveling under the autonomous driving control.

2. The autonomous driving device according to claim 1, wherein:
the specific point is a deceleration point where the operator desires to decelerate the host vehicle, a lane change point where the operator desires to change a lane of the host vehicle, or a stopover point where the operator desires to temporarily stop the host vehicle off the target route;
when the specific point is the deceleration point, the specific travel is deceleration of the host vehicle;
when the specific point is the lane change point, the specific travel is lane change of the host vehicle; and
when the specific point is the stopover point, the specific travel is entry and stop of the host vehicle at the stopover point.

3. The autonomous driving device according to claim 1, wherein the control device is configured to, when the specific point is set by the operator and a performability condition that the host vehicle is able to perform, at the set specific point, the specific travel set in association with the specific point is not satisfied, cause the host vehicle not to perform, at the set specific point, the specific travel set in association with the specific point while the host vehicle is traveling under the autonomous driving control.

4. The autonomous driving device according to claim 3, wherein the control device is configured to, when the performability condition is not satisfied, notify the operator that the host vehicle is unable to perform, at the set specific point, the specific travel set in association with the specific point.
